(19) United States
(12) Patent Application Publication
(10) Pub. No.: US 2026/0368031 A1
(43) Pub. Date: Nov. 19, 2026

(54) DEVICE AND A METHOD FOR IN-MEMORY COMPUTATION

(71) Applicant: Robert Bosch GmbH, Stuttgart (DE)

(72) Inventors: Benjamin Hettwer, Kirchheim Unter Teck (DE); Luca Parrini, Stuttgart (DE); Taha Soliman, Kirchheim (DE); Jan Micha Borrmann, Mannheim (DE)

(21) Appl. No.: 19/674,443

(22) Filed: May 12, 2026

(30) Foreign Application Priority Data
May 16, 2025 (DE) 10 2025 118 980.3

(51) Int. Cl. G06F 11/10; G06F 5/01; G06F 7/544

(52) U.S. Cl. CPC G06F 11/1004; G06F 5/01; G06F 7/5443

(57) ABSTRACT

A device and a method for in-memory computation. The device includes a first processing element and a second processing element. The first processing element includes a first set of memory cells. The second processing element includes a second set of memory cells. The device includes a first crossbar, wherein the first crossbar includes a first subset of memory cells of the first set and a first subset of memory cells of the second set. The device includes a memory cell for determining a checksum for the first subsets. The memory cells include a respective value.

### CROSS REFERENCE

The present application claims the benefit under 35 U.S.C. § 119 of Germany Patent Application No. DE 10 2025 118 980.3 filed on May 16, 2025, which is expressly incorporated herein by reference in its entirety.

### FIELD

The present disclosure concerns a device and a method for in-memory computation.

### BACKGROUND INFORMATION

In-Memory Computation (IMC) may be used for implementing neural networks efficiently in terms of latency and power consumption.

“WESCO: Weight-encoded Reliability and Security Co-design for In-memory Computing Systems”, Zhang et al., ISVLSI 2022 describes a methodology for Reliability and Security Co-design for In-memory Computing Systems.

### SUMMARY

A device for in-memory computation is provided. According to an example embodiment, the device comprises a first processing element and a second processing element, wherein the first processing element comprises a first set of memory cells, wherein the second processing element comprises a second set of memory cells, wherein the device comprises a first crossbar, wherein the first crossbar comprises a first subset of memory cells of the first set and a first subset of memory cells of the second set, wherein the device comprises a memory cell for determining a checksum for the first subsets, wherein the memory cells comprise a respective value, wherein the device is configured for determining a first output depending on the value in the first subset of memory cells, determining a second output depending on the value in the second subset of memory cells, modifying the second output, determining the checksum for the first subsets depending on the value in the memory cell for determining the checksum for the first subsets, determining the sum of the first output and the modified second output, determining a result of subtracting the checksum for the first subsets from the sum of the first output and the modified second output, and determining the output of the second processing element depending on the result.

The device may comprise a memory storing an information indicating that the output of the second processing element is the modified output, wherein the device is configured subtracting the checksum for the first subsets from the sum upon reading the information from the memory.

The device may comprise a memory cell for determining a checksum for the first set of memory cells, wherein the device is configured for determining an output corresponding to the sum of the values in the first set of memory cells, and determining the result upon successfully confirming based on the checksum for the first set of memory cells that the calculation of the output corresponding to the sum of the values in the first set of memory cells is correct.

The device may comprise a memory cell for determining a checksum for the second set of memory cells, wherein the device is configured for determining an output corresponding to the sum of the values in the second set of memory cells, modifying the output corresponding to the sum of the values in the second set of memory cells, and determining the result upon successfully confirming based on the checksum for the first set of memory cells that the difference between the modified output corresponding to the sum of the values in the first set of memory cells and the checksum for the first set of memory cells is the checksum for the first set of memory cells.

The first set of memory cells and the second set of memory cells may comprise values corresponding to weights of a neural network, wherein the neural network comprises a confusion neuron, wherein a memory cell of the second set of memory cells comprises a value corresponding to the weight of confusion neuron.

The device may comprise a second crossbar, wherein the second crossbar comprises a second subset of memory cells of the first set and a second subset of memory cells of the second set, wherein the device comprises a memory cell for determining a checksum for the second subsets, wherein the device is configured for determining a third output depending on the value in the second subset of memory cells of the first set, determining a fourth output depending on the value in the second subset of memory cells of the second set, modifying the fourth output, determining the checksum for the second subsets depending on the value in the memory cell for determining the checksum for the second subsets, and determining the output of the second processing element depending on a result of subtracting the checksum for the second subsets from the sum of the third output and the modified fourth output.

The device may comprise a third processing element, wherein the third processing element comprises a third set of memory cells, wherein the first crossbar comprises a first subset of memory cells of the third set.

The device may be configured for storing bits corresponding to the respective output in a register and for modifying the second output by a left shift of the bits in the register to the second modified output.

A method for in-memory computation comprises determining outputs of a first processing element and a second processing element, wherein the first processing element comprises a first set of memory cells, wherein the second processing element comprises a second set of memory cells, wherein a first crossbar comprises a first subset of memory cells of the first set and a first subset of memory cells of the second set, wherein the memory cells comprise a respective value, wherein determining the outputs comprises determining a first output depending on the value in the first subset of memory cells, determining a second output depending on the value in the second subset of memory cells, wherein the method comprises modifying the second output, determining a checksum for the first subsets depending on a value in a memory cell for determining the checksum for the first subsets, determining the sum of the first output and the modified second output, determining a result of subtracting the checksum for the first subsets from the sum of the first output and the modified second output, and determining the output of the second processing element depending on the result.

The method may comprise reading an information indicating that the output of the second processing element is the modified output from a memory storing the information, subtracting the checksum for the first subsets from the sum upon reading the information from the memory.

The method may comprise determining an output corresponding to the sum of the values in the first set of memory cells with a memory cell for determining a checksum for the first set of memory cells, and determining the result upon successfully confirming based on the checksum for the first set of memory cells that the calculation of the output corresponding to the sum of the values in the first set of memory cells is correct.

The method may comprise determining an output corresponding to the sum of the values in the second set of memory cells with a memory cell for determining a checksum for the second set of memory cells, modifying the output corresponding to the sum of the values in the second set of memory cells, and determining the result upon successfully confirming based on the checksum for the first set of memory cells that the difference between the modified output corresponding to the sum of the values in the first set of memory cells and the checksum for the first set of memory cells is the checksum for the first set of memory cells.

The first set of memory cells and the second set of memory cells may comprise values corresponding to weights of a neural network, wherein the neural network comprises a confusion neuron, wherein a memory cell of the second set of memory cells comprises a value corresponding to the weight of confusion neuron.

A second crossbar may comprise a second subset of memory cells of the first set and a second subset of memory cells of the second set, wherein the method comprises determining a third output depending on the value in the second subset of memory cells of the first set, determining a fourth output depending on the value in the second subset of memory cells of the second set, modifying the fourth output, determining a checksum for the second subsets depending on a value in a memory cell for determining the checksum for the second subsets, and determining the output of the second processing element depending on a result of subtracting the checksum for the second subsets from the sum of the third output and the modified fourth output.

The method may comprise determining outputs of a third processing element, wherein the third processing element comprises a third set of memory cells, wherein the first crossbar comprises a first subset of memory cells of the third set.

The method may comprise storing bits corresponding to the respective output in a register and modifying the second output by a left shift of the bits in the register to the modified second output.

A computer program, wherein the computer program comprises computer-readable instructions that, when executed by a computer, cause the computer to execute the method.

Further examples are derived from the following description and the figures.

### BRIEF DESCRIPTION OF THE DRAWINGS

FIG. 1 schematically depicts a device for in-memory computation, according to an example embodiment.

FIG. 2 depicts a flow chart comprising steps of a method for in-memory computation, according to an example embodiment.

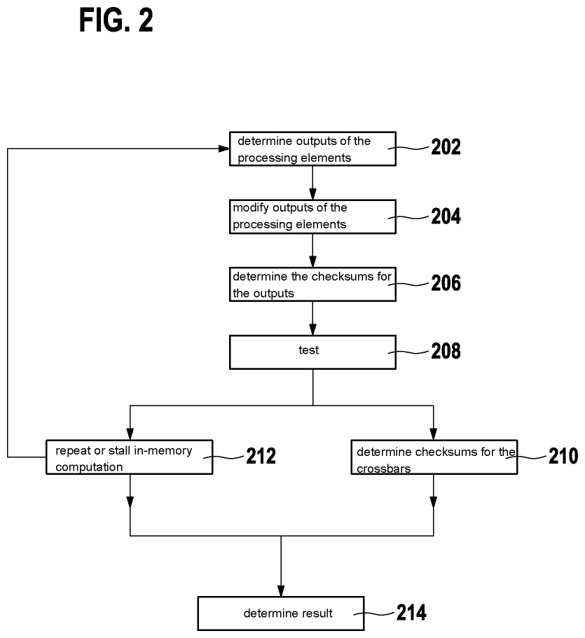

### DETAILED DESCRIPTION OF EXAMPLE EMBODIMENTS

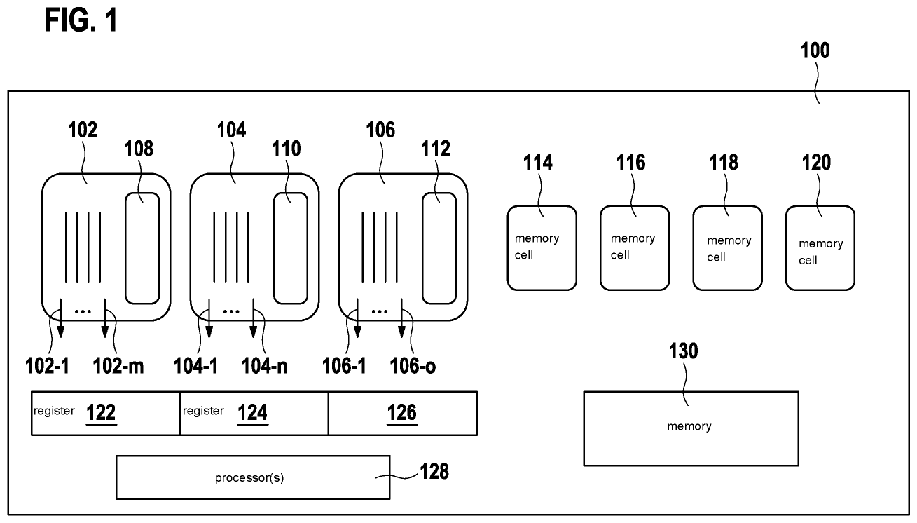

FIG. 1 depicts a device 100 for in-memory computation.

The device 100 comprises a first processing element 102, a second processing element 104, and a third processing element 106.

The first processing element 102 comprises a first set of memory cells aᵢ for in-memory computation of outputs 102-1, . . . , 102-m of the first processing element 102. The first processing element 102 comprises a memory cell 108 for in-memory computation of a checksum for the outputs 102-1, . . . , 102-m of the first processing element 102.

The second processing element 104 comprises a second set of memory cells bᵢ for in-memory computation of outputs 104-1, . . . , 104-n of the second processing element 104. The second processing element 104 comprises a memory cell 110 for in-memory computation of a checksum for the outputs 104-1, . . . , 104-n of the second processing element 104.

The third processing element 106 comprises a third set of memory cells cᵢ for in-memory computation of outputs 106-1, . . . , 106-o of the third processing element 106. The third processing element 104 comprises a memory cell 112 for in-memory computation of a checksum for the outputs 106-1, . . . , 106-o of the third processing element 106.

The device 100 is not limited to using one memory cell for determining the checksum for the outputs of the i-th processing element. The device 100 may comprise multiple memory cells for determining the checksum for the i-th processing element.

The in-memory computation is based on values that are mapped on the memory cells. A respective memory cell represents a value. The memory cell can be either volatile or not. The memory cell may represent the value as resistance or digital, e.g., as bit or bits. The sum of the values in the multiple memory cells for determining the checksum for the i-th processing element is for example the same as the sum of the values in the memory cells of the i-th processing element that are connected to the outputs of the i-th processing element.

The device 100 comprises a first crossbar. The first crossbar comprises a first subset of the first set of memory cells aᵢ, a first subset of the second set of memory cells bᵢ, and a first subset of the third set of memory cells cᵢ. The device 100 comprises a memory cell 114 for in-memory computation of a checksum Σ1 for an output of the first crossbar. The device 100 is for example configured for determining the checksum Σ1 for the first subsets. The memory cell for determining the checksum Σ1 for the first subsets comprises for example, a value that is the same as the sum of the values in the memory cells of the first subsets.

The device 100 comprises a second crossbar. The second crossbar comprises a second subset of the first set of memory cells aᵢ, a second subset of the second set of memory cells bᵢ, and a second subset of the third set of memory cells cᵢ. The device 100 comprises a memory cell 116 for in-memory computation of a checksum for an output of the second crossbar. The device 100 is for example configured for determining the checksum Σ2 for the second subsets. The memory cell for determining the checksum Σ2 for the second subsets comprises for example, a value that is the same as the sum of the values in the memory cells of the second subsets.

The device 100 comprises a third crossbar. The third crossbar comprises a third subset of the first set of memory cells aᵢ, a third subset of the second set of memory cells bᵢ, and a third subset of the third set of memory cells cᵢ. The device 100 comprises a memory cell 118 for in-memory computation of a checksum for an output of the third crossbar. The device 100 is for example configured for determining the checksum Σ3 for the third subsets. The memory cell for determining the checksum Σ3 for the third subsets comprises for example, a value that is the same as the sum of the values in the memory cells of the third subsets.

The device 100 comprises a fourth crossbar. The fourth crossbar comprises a fourth subset of the first set of memory cells aᵢ, a fourth subset of the second set of memory cells bᵢ, and a fourth subset of the third set of memory cells cᵢ. The device 100 comprises a memory cell 120 for in-memory computation of a checksum for an output of the fourth crossbar. The device 100 is for example configured for determining the checksum Σ4 for the fourth subsets. The memory cell for determining the checksum Σ4 for the fourth subsets comprises for example, a value that is the same as the sum of the values in the memory cells of the fourth subsets.

The device 100 is not limited to using one memory cell for determining the checksum Σi for the i-th subsets. The device 100 may comprise multiple memory cells for determining the checksum Σi for the i-th subsets. The sum of the values in the multiple memory cells for determining the checksum Σi for the i-th subsets is for example the same as the sum of the values in the memory cells of the i-th subsets

The device 100 is configured for providing an input voltage to the i-th crossbar and to measure an output current of the j-th output of the k-th processing element for determining the output. The output current corresponds to the sum of the values in the memory cells that connect to the i-th crossbar and the j-th output of the k-th processing element. The device 100 is configured to determine j-th output of the k-th processing element depending on the output current.

The device 100 is configured for determining the input voltage to the respective crossbar. The device 100 can for example comprise a digital to analog converter for determining the input voltage to the i-th crossbar. The device 100 for example comprises an analog to digital converter for determining the j-th output of the k-th processing element depending on the output current.

The device 100 is not limited to three processing elements. The device may comprise two processing elements or more than three processing elements. The device 100 is not limited to four crossbars. The device 100 may comprise one crossbar or two crossbars or three crossbars or more than four crossbars. The device 100 comprises for example multiple crossbars and one memory cell for the respective crossbar of the multiple crossbars at least one memory cell for in-memory computation of the checksum for the respective crossbar

The device 100 is described by way of example of four memory cells in the first set of memory cells aᵢ, i=1, . . . , 4. The device 100 is described by way of example of four memory cells in the second set of memory cells bᵢ, i=1, . . . , 4. The device 100 is described by way of example of four memory cells in the third set of memory cells cᵢ, i=1, . . . , 4.

The device 100 is not limited to four memory cells in the respective set of memory cells. The respective set of memory cells may comprise one memory cell, two memory cells, three memory cells, or more than four memory cells.

The memory cells comprise a respective value.

The sets of memory cells for example comprise values corresponding to weights of a neural network.

The neural network for example comprises a confusion neuron.

For example, a memory cell of the second set of memory cells bi comprises a value corresponding to the weight of confusion neuron.

According to an example, the device 100 comprises a first register 120 for storing the outputs 102-1, . . . , 102-m of the first processing element 102.

According to an example, the device 100 comprises a second register 122 for storing the outputs 104-1, . . . , 104-n of the second processing element 104.

According to an example, the device 100 comprises a third register 124 for storing the outputs 106-1, . . . , 106-o of the third processing element 106.

The device 100 is not limited to three registers. The device 100 may comprise one register for the output of the respective processing element of the device 100.

According to an example, wherein the values are represented by resistances, the device 100 comprises at least one processor 128. The at least one processor 128 is configured to provide the input voltage to the crossbars and to measure the current of the outputs. The processor 128 for example comprises the analog to digital converter. The at least one processor 128 for example comprises the digital to analog converter. For digital representation of the values, the at least one processor 128 may be configured to read out the respective value and add the respective values digitally.

The device 100 is configured for modifying the outputs of at least one of the processing elements of the device 100. The device 100 is for example configured for shifting the outputs left once for modifying the outputs. The device 100 is for example configured for not shifting outputs left that are not to be modified.

According to an example, the device 100 comprises a memory 130 storing an information indicating the outputs of which processing element to modify.

The processing elements are for example associated with an index. The information indicates the index of the processing element of which the outputs are to be modified. The information comprises for example one bit for each processing element, and a one hot encoding of the processing element of which the outputs are to be modified.

The processor 128 for example configured to read the information from the memory 130 and to modify the outputs of the processing element according to the information. The at least one processor 128 for example configured for left shifting the outputs in the register comprising the outputs to be modified.

According to an example, the at least one processor 128 for executing instructions that, when executed by the processor 124 causes the device 100 to execute a method for in-memory computation.

The method for in-memory computation is described by way of example of the information indicating that the second processing element 104 outputs the output to be modified.

The method comprises a step 202.

The step 202 comprises determining the outputs of the processing elements.

The method comprises a step 204.

The step 204 comprises modifying the outputs of the second processing element 104.

The method comprises a step 206.

The step 206 comprises determining the checksums for the outputs.

The method comprises a step 208.

The step 208 comprises testing, depending on the checksums, whether the outputs and the checksums are determined correctly.

In case the outputs and the checksums are determined correctly, a step 210 is executed.

Otherwise, a step 212 is executed.

The step 212 comprises repeating or stalling the in-memory computation. For example, the step 202 is executed to repeat the in-memory computation. For example, the in-memory computation is stalled to determine a corrected output of at least one of the processing elements. For example, the step 210 is executed after successfully correcting the output of the at least one of the processing elements. For example, the step 202 is executed upon failing to correct the output of the at least one of the processing elements.

The step 210 comprises determining the checksums for the crossbars.

Afterwards, a step 214 is executed.

The step 214 comprises determining a result of the in-memory computation depending on the checksums for the crossbars.

For the device 100 comprising the three processing elements, the four crossbars, and the four memory cells in the set of memory cells of the respective processing element, the method comprises for example:

Determining a checksum Σa for the outputs of the first processing element 102 that result from providing the input voltage to the first processing element 102, i.e., the outputs that depends on the memory cells a₁, a₂, a₃, a₄.

Determining a checksum Σb for the outputs of the second processing element 104 that result from providing the input voltage to the second processing element 104, i.e., the outputs that depends on the memory cells b₁, b₂, b₃, b₄.

Determining a checksum Σc for the outputs of the third processing element 106 that result from providing the input voltage to the third processing element 106, i.e., the outputs that depends on the memory cells c₁, c₂, c₃, c₄.

Determining a checksum Σ1 for the outputs that result from providing the input voltage to the first crossbar, i.e., the outputs that depends on the memory cells a₁, b₁, c₁.

Determining a checksum Σ2 for the outputs that result from providing the input voltage to the second crossbar, i.e., the outputs that depend on the memory cells a₂, b₂, c₂.

Determining a checksum Σ3 for the outputs that result from providing the input voltage to the third crossbar, i.e., the outputs that depend on the memory cells a₃, b₃, c₃.

Determining a checksum Σ4 for the outputs that result from providing the input voltage to the fourth crossbar, i.e., the outputs that depend on the memory cells a₄, b₄, c₄.

The outputs and the checksums depend on the value in the memory cells that connect to the respective output.

Subtracting the checksum Σ1 from the sum of the outputs that depend on the memory cells a₁, b₁, c₁ to determine the corrected output of the second processing element 104 that depends on the memory cell b₁. Notably, the sum of the outputs that depend on the memory cells a₁, b₁, c₁ is determined depending on the unmodified outputs that depend on the memory cells a₁, c₁ and depending on the modified output that depends on the memory cell b₁.

For the example of a single left shift, i.e., a multiplication by two, the corrected output of the second processing element 104 that depends on the memory cell b₁ corresonds to the value in the respective memory cells as follows:

b₁=a₁,+2 b₁+c₁−Σ1

Subtracting the checksum Σ2 from the sum of the outputs that depend on the memory cells a₂, b₂, c₂ to determine the corrected output of the second processing element 104 that depends on the memory cell b₂. Notably, the sum of the outputs that depend on the memory cells a₂, b₂, c₂ is determined depending on the unmodified outputs that depend on the memory cells a₂, c₂ and depending on the modified output that depends on the memory cell b₂.

For the example of a single left shift, i.e., a multiplication by two, the corrected output of the second processing element 104 that depends on the memory cell b₁ corresonds to the values in the respective memory cells as follows:

b₂=a₂,+2 b₂+c₂−Σ2

Subtracting the checksum Σ3 from the sum of the outputs that depend on the memory cells a₃, b₃, c₃ to determine the corrected output of the second processing element 104 that depends on the memory cell b₃. Notably, the sum of the outputs that depend on the memory cells a₃, b₃, c₃ is determined depending on the unmodified outputs that depend on the memory cells a₃, c₃ and depending on the modified output that depends on the memory cell b₃.

For the example of a single left shift, i.e., a multiplication by two, the corrected output of the second processing element 104 that depends on the memory cell b₁ corresonds to the values in the respective memory cells as follows:

b₃=a₃,+₂ b₃+c₃−Σ3

Subtracting the checksum Σ4 from the sum of the outputs that depend on the memory cells a₄, b₄, c₄ to determine the corrected output of the second processing element 104 that depends on the memory cell b₄. Notably, the sum of the outputs that depend on the memory cells a₄, b₄, c₄ is determined depending on the unmodified outputs that depend on the memory cells a₄, c₄ and depending on the modified output that depends on the memory cell b₄.

For the example of a single left shift, i.e., a multiplication by two, the corrected output of the second processing element 104 that depends on the memory cell b₄ corresonds to the values in the respective memory cells as follows:

b₄=a₄,+2 b₄+c₄−Σ4

What is claimed is:

1. A device for in-memory computation, comprising:
a first processing element and a second processing element, wherein the first processing element includes a first set of memory cells, and the second processing element includes a second set of memory cells;
a first crossbar, wherein the first crossbar includes a first subset of memory cells of the first set and a first subset of memory cells of the second set;
a memory cell for determining a checksum for the first subset of memory cells of the first set and the first subset of memory cells of the second set;
wherein each of the memory cells includes a respective value;
wherein the device is configured to:
determine a first output depending on the respective values in the first subset of memory cells of the first set,
determine a second output depending on the respective values in the first subset of memory cells of the second set,
modify the second output,
determine a checksum for the first subset of memory cells of the first set and the first subset of memory cells of the second set, depending on the value in the memory cell for determining the checksum for the first subset of memory cells of the first set and the first subset of memory cells of the second set,
determine a sum of the first output and the modified second output,
determine a result of subtracting the checksum for the first subset of memory cells of the first set and the first subset of memory cells of the second set from the sum of the first output and the modified second output, and
determine an output of the second processing element depending on the result.

2. The device according to claim 1, further comprising:
a memory storing information indicating that the output of the second processing element is the modified output;
wherein the device is configured to subtract the checksum for the first subset of memory cells of the first set and the first subset of memory cells of the second set, from the sum upon reading the information from the memory.

3. The device according to claim 1, further comprising:
a memory cell for determining a checksum for the first set of memory cells;
wherein the device is configured to:
determine an output corresponding to the sum of the respective values in the first set of memory cells, and
determine the result upon successfully confirming based on the checksum for the first set of memory cells that a calculation of an output corresponding to the sum of the respective values in the first set of memory cells is correct.

4. The device according to claim 1, further comprising:
a memory cell for determining a checksum for the second set of memory cells;
wherein the device is configured to:
determine an output corresponding to the sum of the respective values in the second set of memory cells,
modify the output corresponding to the sum of the respective values in the second set of memory cells, and
determine the result upon successfully confirming based on the checksum for the second set of memory cells that a difference between the modified output corresponding to the sum of the respective values in the second set of memory cells and the checksum for the second set of memory cells is the checksum for the second set of memory cells.

5. The device according to claim 1, wherein the first set of memory cells and the second set of memory cells include values corresponding to weights of a neural network, wherein the neural network includes a confusion neuron, wherein a memory cell of the second set of memory cells includes a value corresponding to a weight of the confusion neuron.

6. The device according to claim 1, further comprising:
a second crossbar, wherein the second crossbar includes a second subset of memory cells of the first set and a second subset of memory cells of the second set;
a memory cell for determining a checksum for the second subset of memory cells of the first set and the second subset of memory cells of the second set;
wherein the device is configured to:
determine a third output depending on the respective values in the second subset of memory cells of the first set,
determine a fourth output depending on the respective values in the second subset of memory cells of the second set,
modify the fourth output,
determine a checksum for the second subset of memory cells of the first set and the second subset of memory cells of the second set, depending on a value in the memory cell for determining the checksum for the second subset of memory cells of the first set and the second subset of memory cells of the second set, and
determine the output of the second processing element depending on a result of subtracting the checksum for the second subset of memory cells of the first set and the second subset of memory cells of the second set, from a sum of the third output and the modified fourth output.

7. The device according to claim 1, further comprising:
a third processing element, wherein the third processing element includes a third set of memory cells, wherein the first crossbar includes a first subset of memory cells of the third set.

8. The device according to claim 1, wherein the device is configured to store bits corresponding to the respective output in a register and to modify the second output by a left shift of the bits in the register to the modified second output.

9. A method for in-memory computation, comprising the following steps:
determining outputs of a first processing element and a second processing element, wherein the first processing element includes a first set of memory cells, wherein the second processing element includes a second set of memory cells, wherein a first crossbar includes a first subset of memory cells of the first set and a first subset of memory cells of the second set, wherein each of the memory cells includes a respective value, wherein the determining of the outputs includes:
determining a first output depending on respective values in the first subset of memory cells of the first set,
determining a second output depending on the respective values in the first subset of memory cells of the second set,
modifying the second output,
determining a checksum for the first subset of memory cells of the first set and the first subset of memory cells of the second set, depending on a value in a memory cell for determining the checksum for the first subset of memory cells of the first set and the first subset of memory cells of the second set,
determining a sum of the first output and the modified second output,
determining a result of subtracting the checksum for the first subset of memory cells of the first set and the first subset of memory cells of the second set, from the sum of the first output and the modified second output, and
determining the output of the second processing element depending on the result.

10. The method according to claim 9, further comprising:
reading information indicating that the output of the second processing element is the modified output, from a memory storing the information,
subtracting the checksum for the first subset of memory cells of the first set and the first subset of memory cells of the second set, from the sum of the first output and the modified second output upon reading the information from the memory.

11. The method according to claim 9, further comprising:
determining an output corresponding to a sum of the respective values in the first set of memory cells with a memory cell for determining a checksum for the first set of memory cells, and
determining the result upon successfully confirming based on the checksum for the first set of memory cells that a calculation of the output corresponding to the sum of the respective values in the first set of memory cells is correct.

12. The method according to claim 9, further comprising:
determining an output corresponding to a sum of the respective values in the second set of memory cells with a memory cell for determining a checksum for the second set of memory cells,
modifying the output corresponding to the sum of the respective values in the second set of memory cells, and
determining the result upon successfully confirming based on the checksum for the second set of memory cells that a difference between the modified output corresponding to the sum of the respective values in the second set of memory cells and the checksum for the second set of memory cells is the checksum for the second set of memory cells.

13. The method according to claim 9, wherein the first set of memory cells and the second set of memory cells include values corresponding to weights of a neural network, wherein the neural network includes a confusion neuron, wherein a memory cell of the second set of memory cells includes a value corresponding to a weight of the confusion neuron.

14. The method according to claim 9, wherein a second crossbar includes a second subset of memory cells of the first set and a second subset of memory cells of the second set, and wherein the method further comprises:
determining a third output depending on the respective values in the second subset of memory cells of the first set,
determining a fourth output depending on the respective values in the second subset of memory cells of the second set,
modifying the fourth output,
determining a checksum for the second subset of memory cells of the first set and the second subset of memory cells of the second set, depending on a value in a memory cell for determining the checksum for the second subset of memory cells of the first set and the second subset of memory cells of the second set, and
determining the output of the second processing element depending on a result of subtracting the checksum for the second subset of memory cells of the first set and the second subset of memory cells of the second set from a sum of the third output and the modified fourth output.

15. The method according to claim 9, further comprising:
determining outputs of a third processing element, wherein the third processing element includes a third set of memory cells, and wherein the first crossbar includes a first subset of memory cells of the third set.

16. The method according to claim 9, further comprising:
storing bits corresponding to the respective output in a register, and
modifying the second output by a left shift of the bits in the register to the modified second output.

17. A non-transitory computer-readable medium on which is stored a computer program including computer-readable instructions for in-memory computation, the instructions, when executed by a computer, causing the computer to perform the following steps:
determining outputs of a first processing element and a second processing element, wherein the first processing element includes a first set of memory cells, wherein the second processing element includes a second set of memory cells, wherein a first crossbar includes a first subset of memory cells of the first set and a first subset of memory cells of the second set, wherein each of the memory cells includes a respective value, wherein the determining of the outputs includes:
determining a first output depending on respective values in the first subset of memory cells of the first set,
determining a second output depending on the respective values in the first subset of memory cells of the second set,
modifying the second output,
determining a checksum for the first subset of memory cells of the first set and the first subset of memory cells of the second set, depending on a value in a memory cell for determining the checksum for the first subset of memory cells of the first set and the first subset of memory cells of the second set,
determining a sum of the first output and the modified second output,
determining a result of subtracting the checksum for the first subset of memory cells of the first set and the first subset of memory cells of the second set, from the sum of the first output and the modified second output, and
determining the output of the second processing element depending on the result.
